(19) United States
(12) Patent Application Publication
(10) Pub. No.: US 2004/0155815 A1
(43) Pub. Date: Aug. 12, 2004

(54) Wireless navigational system, device and method

(75) Inventors: George W. Muncaster, Phoenix, AZ (US); William B. Austin, Chandler, AZ (US)

Correspondence Address: MOTOROLA INC, 5401 NORTH BEACH STREET, MAILSTOP E230, FORT WORTH, TX, 76137

(73) Assignee: MOTOROLA, INC.

(21) Appl. No.: 09/854,708

(22) Filed: May 14, 2001

(51) Int. Cl. G01S 5/02

(52) U.S. Cl. 342/357.09

(57) ABSTRACT

A system, device and method for assisting navigation are disclosed. The system comprises at least one positioning support device and a personal portable wireless user device. The positioning support device is operable to be placed near a navigation feature and to communicate appropriate navigational information, including absolute position and relative position with respect to a navigational feature. The user device is operable to receive the navigational information and communicate it to a user. The method operates to permit users to independently navigate local, overland or underwater areas and is especially useful for persons who whose vision may be impaired.

### TECHNICAL FIELD OF THE INVENTION

This invention relates to the field of navigation and more specifically to a method and system for a distributed non-visual wireless navigation system, method, and apparatus.

### BACKGROUND OF THE INVENTION

Many visually impaired individuals rely on service animals, primarily seeing eye dogs, to assist them in safe travel. Unfortunately, seeing eye dogs are not a complete answer for the visually impaired. Many visually impaired persons are unable to learn to use a seeing eye dog. Others, due to limitations that are a result of their disabilities, are unable to care for seeing eye dogs. Seeing eye dogs are also expensive due to extensive training and maintenance costs. Dogs also have a limited useful life span.

Because of those drawbacks, various technological solutions have been proposed. One such solution is to use an electronic system to sense an individual's surroundings and then stimulate selected portions of the individual's nervous system to give an indication of the individual's surroundings. Certain visually impaired persons can be trained to recognize these patterns for use in short-term navigation. Such solutions tend to be very complex, possibly medically intrusive, and expensive. They may also require more extensive and lengthy user training than required for a seeing eye dog. Other proposed systems also tend to be complex and expensive. What is needed instead is a simple personal, portable, wireless navigational system, method, and user devices, which are simple to learn and use and which yield results comparable to, or better than, current dog-assisted methods.

### BRIEF DESCRIPTION OF THE DRAWINGS

For a more complete understanding of the present invention and advantages thereof, reference is now made to the following descriptions, taken in conjunction with the following drawings, in which like reference numerals represent like parts, and in which:

FIG. 1 illustrates an exemplary embodiment in accordance with the present invention;

FIG. 2 illustrates a user device and positioning support device in accordance with the teachings of the present invention;

FIG. 3 illustrates an embodiment according to the present invention illustrating a series of positioning support devices, which are networked together in an area;

FIG. 4 is an illustration of an underwater embodiment according to the present invention;

FIG. 5 is an illustration of an overland embodiment according the present invention; and

FIG. 6 is a flow chart illustrating an embodiment according to the present invention system and method.

### DETAILED DESCRIPTION OF THE DRAWINGS

FIG. 1 illustrates an exemplary embodiment according to the present invention. Illustrated is a user 102, who is, in one embodiment, visually impaired. A visually impaired user can be permanently visually impaired or be rendered visually impaired due to some environmental condition or other situation. User 102 is equipped with a personal portable wireless navigational device 104.

Implanted in sidewalk 106 are positioning support devices 108. In this example, positioning support devices 108 are located before alley 110. In use, user 102, a visually impaired individual, is traveling with personal portable wireless navigational device 104 activated. Personal portable wireless navigational device 104 is operable to communicate wirelessly with positioning support device 108 and provide audio or tactile feedback to user 102. Positioning support devices 108 are placed near navigational features. These may be navigational hazards, such as an alley or intersection, navigational points of relevance, such as the location of a pharmacy, or any other navigational waypoint.

The navigational feature may be permanent, time or location dependent or even moveable.

In FIG. 1, positioning support device 108 is placed near or in proximity to sidewalk 106. As user 102 approaches positioning support device 108, personal portable wireless navigational device 104 and positioning support device 108 exchange communication signals with each other by wireless means. This exchange is needed because it insures that both personal portable wireless navigational device 104 and positioning support device 108 are able to adapt to and interpret each other's signals correctly and accurately. Note that personal portable wireless navigational device 104 is mobile, and that positioning support device 108 may also be mobile; that is, affixed to a moving or temporary structure, such as construction, vehicles, material item or bundle, and the like. Ultimately, positioning support devices 108 could be built, or retrofitted, into or onto each highway vehicle to provide as an effective public service, adequate warning to sensory-impaired persons.

Also in use, both devices may be capability addressable; that is, capable of signaling to each other their data rate(s), buffer capacity, synchronization information, computational accuracy/calibration information, and the like. Capability addressability helps to better insure successful positioning outcomes by providing information that is understandable to a wide variety of devices that have different capabilities. As a result of such communications exchange, for example, personal portable wireless navigational device 104 may then provide audio or tactile feedback to user 102 based on information received from positioning support device 108. In one embodiment, positioning support device 108 can continuously broadcast navigational information such as “approaching an alley”, “curb ahead”, “East-West signal malfunction” or other useful navigational information. Depending on the capabilities of personal portable wireless navigational device 104 and the needs of user 102, personal portable wireless navigational device 104 can communicate the navigational information to user 102 in a format useable by both the user 102 and supported by the personal portable wireless navigational device 104. This is the basis of the capability addressable format. Note that the navigational information communicated is not just an indication of where user 102 is located, as could be received by a conventional GPS receiver, which at best only provides information that a GPS receiver can use to fix a location. Instead, in the present invention, the navigational information helps a user navigate about a city or other location.

For example, according to user established device input/output preferences, the personal portable wireless navigational device 104 provides feedback to the user 102 in a manner and format suitable for each user's ability to perceive and comprehend. This is known as content accessibility. For example, depending on the user 102 capability and personal preferences, one or more of audible, visual, tactile, or other type of feedback means may be emitted by the personal portable wireless navigational device 104. Further, for example, depending on user 102 capability, the personal portable wireless navigational device 104 may issue a series of beeps or other audible tones, light flashes of specified intensity and/or color, ordinary speech such or working generated speech, or may vibrate or shake or provide other tactile feedback in a manner so as to communicate to user 102 the proximity, distance, exact location, and/or nature of the navigational hazard or other relevant features being approached.

Further, system and/or device sensitivity, accuracy, information contents exchanges, and the like, may all be tailorable and configurable to the specific purpose, so that, for example, messaging information rate, response distance and time, and the like may be a function of the specific navigation waypoint, route, dangers, etc.

In one embodiment, personal portable wireless navigational device 104 and/or positioning support device 108 may be equipped with a Global Positioning System (GPS) or Glonass receiver, or with other public or private open or proprietary capabilities to improve the accuracy of positioning or timing information necessary to accomplish the purpose of this invention. For example, one or more local differential GPS (DGPS) capable nodes can be used to refine user 102's position to very high levels of accuracy and precision to insure safer navigation in congested or built-up areas when such improved positioning/location is required. In concert with networked positioning support devices 108, and establishing the precision placement of such devices, user positioning can also be determined to very high accuracy and precision.

While FIG. 1 illustrates positioning support devices 108 mounted in a sidewalk 106, positioning support device 108 can be mounted anywhere near the area where a user 102 might need indication of upcoming fixed or moveable navigational hazards or other relevant features, including hazards or features below grade, at ground level (e.g., attached to a wall/post/overhead object, vehicles, etc.) and the like). Furthermore, this invention does not require a clear signaling line of sight since information content such as the existence of a navigational hazard, rather than simply instantaneous range between devices, is what is of most relevance.

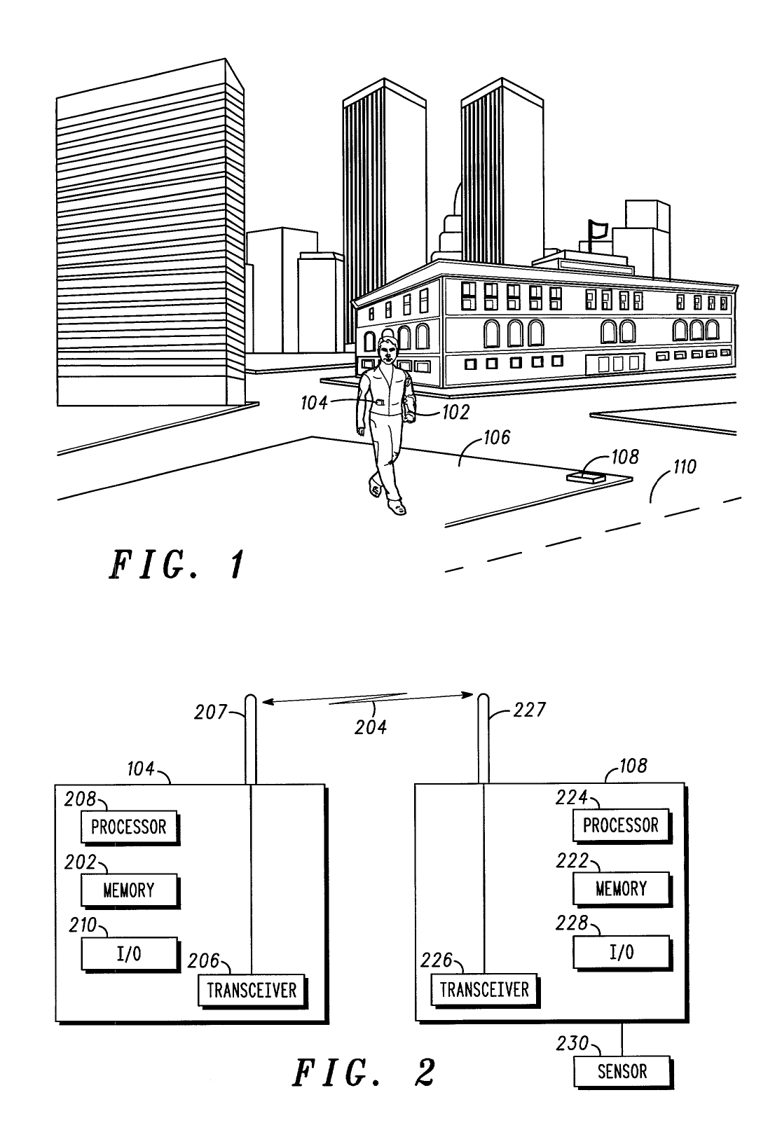

FIG. 2 is a block diagram illustrating personal portable wireless navigational device 104 and a positioning support device 108. Personal portable wireless navigational device 104, in one embodiment, includes a processor 208, input/output (“I/O”) devices 210, memory 202, transceiver 206 and antenna 207. Processor 208, under the control of an operating system, controls the operation of personal portable wireless navigational device 104 and is used to retrieve, process, store, and communicate data. Operating system and any necessary application programs are stored in memory 202. Memory 202 may be implemented as volatile or nonvolatile memory, random access memory (“RAM”), read-only memory (“ROM”), embedded, peripheral, or other types of memory.

Processor 208 can typically be implemented in several ways, including as a microprocessor, such as those manufactured by INTEL, MOTOROLA, or HITACHI. Processor 208 communicates control, address, and data signals with the operating system and with the remaining components of personal portable wireless navigational device 104. Processor 208 interprets and executes instructions that have been fetched or retrieved from memory 202 and may be implemented as a single integrated circuit or as a combination of integrated circuits.

I/O devices 210 include any embedded, attached or peripheral device that allow data to be communicated to and from a user 102 via personal portable wireless navigational device 104 and may include such devices as a speaker, a microphone, or a tactile feedback or other transducer of sensory input. In an alternative embodiment, if personal portable wireless navigational device 104 is to be used by non-visually impaired individuals, it may include other types of I/O devices 210 such as a display, coding/patterns of lights, or other methods of generating visible cues to user 102. Personal portable wireless navigational device 104 includes a wireless receiver/transceiver (transceiver) 206, coupled to antenna 207, to receive information from positioning support device 108 and, in certain embodiments, transmit information to positioning support device 108 via wireless communication link 204.

Positioning support device 108 typically includes a memory 223, a processor 224, a wireless receiver/transmitter (transceiver) 226, an antenna 227 and input/output devices 228. Processor 224 controls the operation of positioning support device 108. Processor 224 can be implemented in several ways, including as a microprocessor similar to processor 208 used in personal portable wireless navigational device 104 and then the processor 224 operates similarly to processor 208 contained in personal portable wireless navigational device 104. Positioning support device 108 may also include I/O devices or modules 228 used to communicate with external sensor(s) 230 to detect changes in environmental conditions, such as ice, rain or fog, etc. Such external sensor 230 information may be used to trigger a change of message or an added message such as “slippery sidewalk” or “caution low visibility”. In the case of a visually impaired individual, the knowledge of particular environmental conditions, such as ice or low visibility, could help or warn the user 102 to proceed more safely (e.g., icy walkways or other dangerous conditions) or to alert others (e.g., vehicle operators) in, for example, low visibility conditions, where the presence of an impaired user 102 could be difficult to detect.

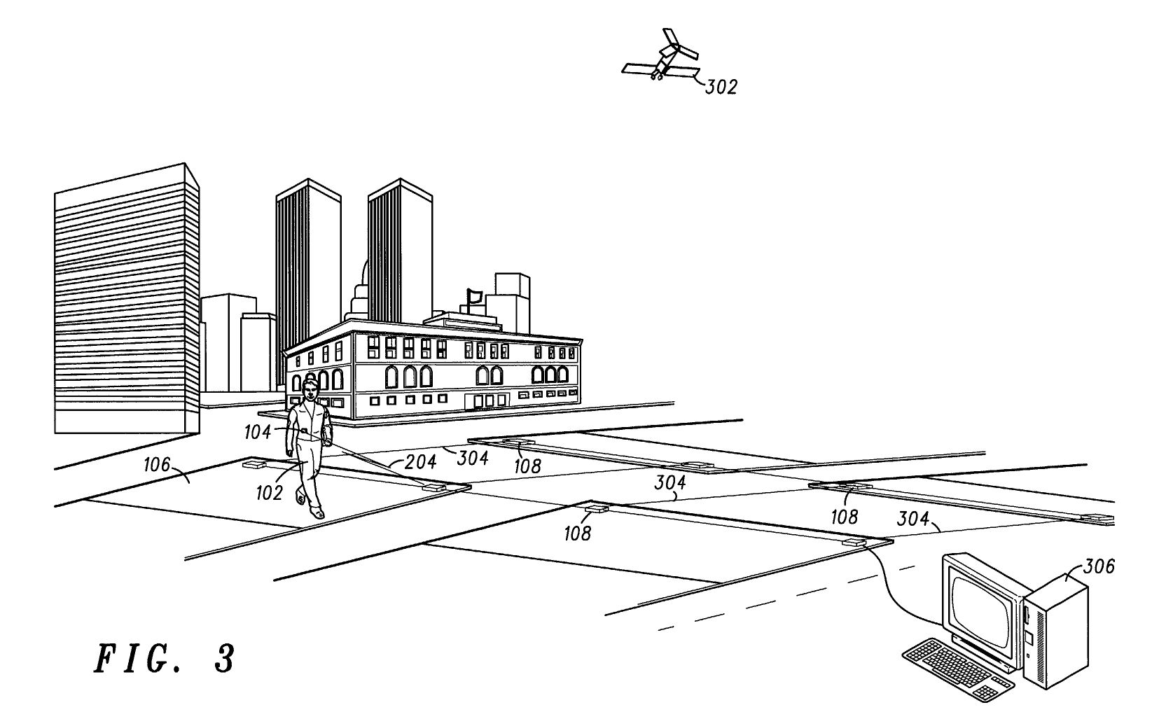

Positioning/navigational messages can be stored in memory 222 and transmitted by transmitter 226. For fixed obstacles, or terrain alterations, or temporary placement of a navigation hazard (truck, load of building materials, etc.), such position of each obstacle can be stored by the personal portable wireless navigational device 104 for navigational reuse to achieve computational economy, etc., as necessary. This facilitates ease of navigation within a defined area, such as the home, workplace, local neighborhood, or other locales frequented by user 102. In alternative embodiments, positioning support device 108 may include a more capable transceiver 228 with the added capability to receive information content. Positioning support device 108 may also include the capability for customization of messages and reprogramming of messaging content and of accessing and processing internal applications from a remote server, as illustrated in FIG. 3 or other remote information source.

FIG. 3 illustrates, according to the present invention, an array or series of positioning support devices 108 in an area. Device coverage volumes may overlap, as each positioning support device 108 may be permanently or semi-permanently located or alternatively affixed to a mobile or transportable element able to affect personal navigation. One or more positioning support devices 108 may operate independently or may be networked together. Likewise, multiple positioning support devices 108 may intercommunicate to share and transfer awareness of the presence of proximate users 102. Illustrated is user 102 with personal portable wireless navigational device 104. In this embodiment, positioning support devices 108 are networked together by one or more communications links 304. Positioning support devices 108 may also be networked with a remote server 306, which may also locally or in a more extended fashion share and transfer awareness of the presence of proximate users 102 in the vicinity of or moving between any networked positioning support devices 108. Remote server 306 may also transmit instructions for modifying individual message content to be transmitted by positioning support device 108 to user 102, according to capabilities of user 102. Remote server 306 may also act to transmit, on a temporary or permanent basis, instructions for reprogramming positioning support device 108. Such instructions may thus modify, update, or stop device operations via control messages or by altering applications software. Each networked positioning support device 108 can adapt to the failure, addition or removal of an individual positioning support device 108 by shifting message communications duties between remaining functional individual positioning support devices.

If user 102 is visually or otherwise impaired, personal portable wireless navigational device 104 may be operable to provide navigational information in content-accessible format; that is, according to the capabilities and needs of each user 102. Such information may be supplied by any or all of diverse methods, which may be tailored to the capabilities both of user 102 and personal portable wireless navigation device 104. For example, information may be communicated to a user 102 by personal portable wireless navigational device 104 by audio, visual, tactile, multimedia, etc., sensory inputs according to user-specified preferences. Thus, personal portable wireless navigational device 104 may interpret and provide tailored information output(s) to user 102 in response to one or more “standard” messages sent by positioning support devices 108.

In another embodiment of this invention, positioning support devices 108 may be distributed over an extended area, such as a city block or shopping district, etc., and thereby provide comprehensive positioning/navigational coverage over the extended area. Positioning support devices 108 may also be operable to receive information from remote positioning/location/navigation support systems (e.g., global positioning system [GPS] satellites 302), as well as information from other positioning support devices 108 via communication links 304 and also from remote server 306. Communication links 304 may be wired or wireless. Information accuracy may be enhanced via several different methods, including use of GPS satellites 302, local and/or regional differential GPS signals, and information supplied by a single positioning support device 108, an array or sequence of positioning support devices 108 or networked information supplied by remote server 306 and communicated to user 102 by a local positioning support device 108. These methods will allow any positioning support device 108 to determine its location with great accuracy. This location information is then, in turn, provided to personal portable wireless navigational device 104. This approach also permits more remote positioning support devices 108 to transmit relevant positioning/navigational support information, such as proximity or distance to a specific location, nature of a navigational hazard or other relevant feature to proximate positioning support device 108 for purposes of extended distance navigation. For non-visually-impaired individuals, personal portable wireless navigational device 104 may provide a map on a display. Suggested navigation route(s) around the area shown by the map may be provided by positioning support devices 108.

Also in this embodiment, positioning support devices 108 are operable to transmit information regarding navigational hazards and other relevant features to user device 104. This can be information regarding alleys, potholes, closed sidewalks and the like. This information can be preprogrammed into positioning support devices in the cases where the navigational hazards are fixed and permanent. Alternatively, remote server 306 can be used to send transient information, such as timing of sidewalk or roadway closures, environmental conditions (e.g., ice, barricades, etc.), and other nonpermanent conditions regarding temporary navigational hazards or other relevant features to positioning support devices 108.

Additionally, remote server 306 can send additional information to a user 102 via communications links 304 between remote server 306 and positioning support devices 108 which are then routed ultimately to user 102 via communications link 204 between a personal portable wireless navigational device 104 and a proximate positioning support device 108. This information may include such information as alternative situation- or time-dependent routing, overall navigational system coverage boundaries, boundaries outside of which the immediate navigational hazard is not of concern, and the like.

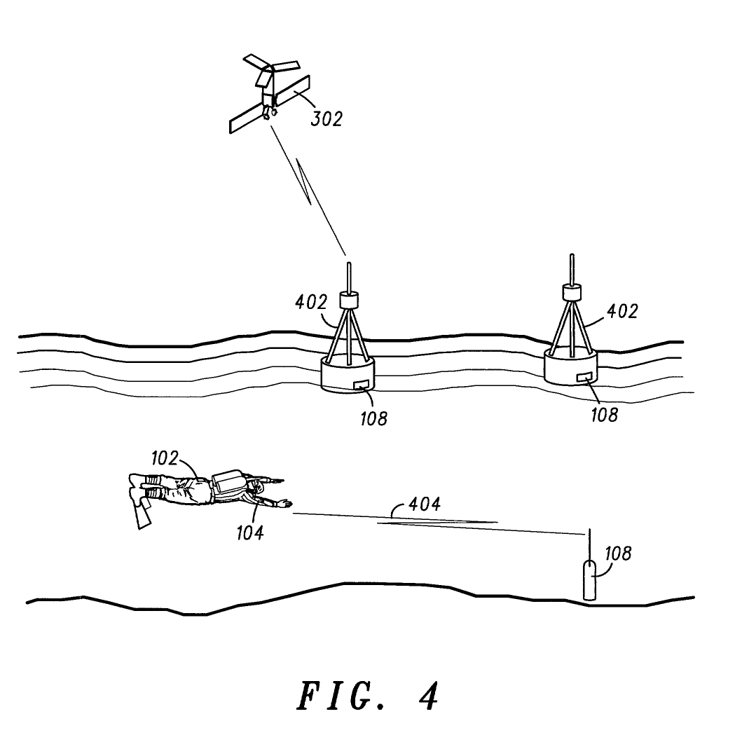

FIG. 4 illustrates an alternative embodiment according to this invention that addresses underwater navigation. In this embodiment, positioning support devices 108 can be placed underwater or allowed to be tethered or to float at the surface of a body of water, e.g., by being attached to a buoy 402 or similar device.

In this embodiment, user 102 may be swimming or diving underwater. The user may be a recreational diver, a member of a search and rescue team, a military diver or other user that requires accurate navigation in water. User 102 has a personal portable wireless navigational device 104, which receives transmissions from positioning support device 108 via underwater communications link 404. In this embodiment, personal portable wireless navigational device 104 may be attached to or included in an item worn or carried by user 102 for ease of use. Positioning support devices 108 may transmit underwater communications link 404 using a radio frequency signal, using long range sonar, or using some other type or frequency of signal that will propagate under water. Personal portable wireless navigational device 104, which has been designed to operate under water, may be attached to user 102 for ease of use. Positioning support devices 108, as discussed earlier, may either be located under water or attached to a buoy 402 or other floating device. Positioning support devices 108, as discussed previously, will broadcast navigational information to the personal portable wireless navigational device 104. The type of information communicated to the user 102 depends on the capabilities of personal portable wireless navigational device 104 and the need of the user 102 and can be text messages displayed on a screen, tactile feedback, visual feedback, voice or other audible feedback, or other communicative means. When positioning support device 108 is attached to a buoy 402 or similar floating device, positioning support device 108 can receive information directly from remote positioning/location/navigation support systems (e.g., global positioning system [GPS] satellites 302), as well as information relayed indirectly via other positioning support devices 108 via communication links 304 (typically wireless) and/or from remote server 306. Positioning support device 108 can relay such external positioning/location information to personal portable wireless navigational device 104 in possession of user 102 via proximate communications link 404.

In operation, a user 102 with personal portable wireless navigational device 104 is underwater and receives navigational information via communication link 404 from a positioning support device 108. As discussed previously, positioning support devices 108 can be used to mark fixed or moveable navigational hazards or other points of relevance. For example, user 102 may be a rescue diver performing a salvage or recovery operation in open water, a lake or river, etc. System is especially useful in deep water where sunlight may not penetrate, or in sandy, muddy, or turbid waters. Positioning support devices 108 may be deployed in order to establish reference grid areas for facilitating searching by the user (diver) 102. In this embodiment, grid coordinates may be programmed into each positioning support device 108 to facilitate user 102 intended operations. In another embodiment, positioning support devices 108 can be deployed by a forward user(diver) 102 in an undersea environment to allow subsequent divers to follow a safe course. Additionally, positioning support devices 108 can be used to mark fixed or movable underwater hazards or other points of relevance, such as shipwrecks or sensitive environmental areas.

While the above aspects of FIG. 4 addressed underwater navigation, the same concepts may be used to guide above-water traffic. For example, positioning support devices 108 can be deployed on buoys 402 or immersed in or below the surface of the water or operate from a shore-based station to mark submerged hazards such as trees, sandbars, undertow currents, or debris, and the like that could hamper surface vessels, swimmers, water-skiers, or other recreational or commercial users 102. Additionally, positioning support device 108 located above or below the water's surface can warn vessels and their operators about variable hazard conditions, such as tidal dependent shoals and ecologically sensitive areas, such as no-wake zones, etc. This could help protect animals such as manatees.

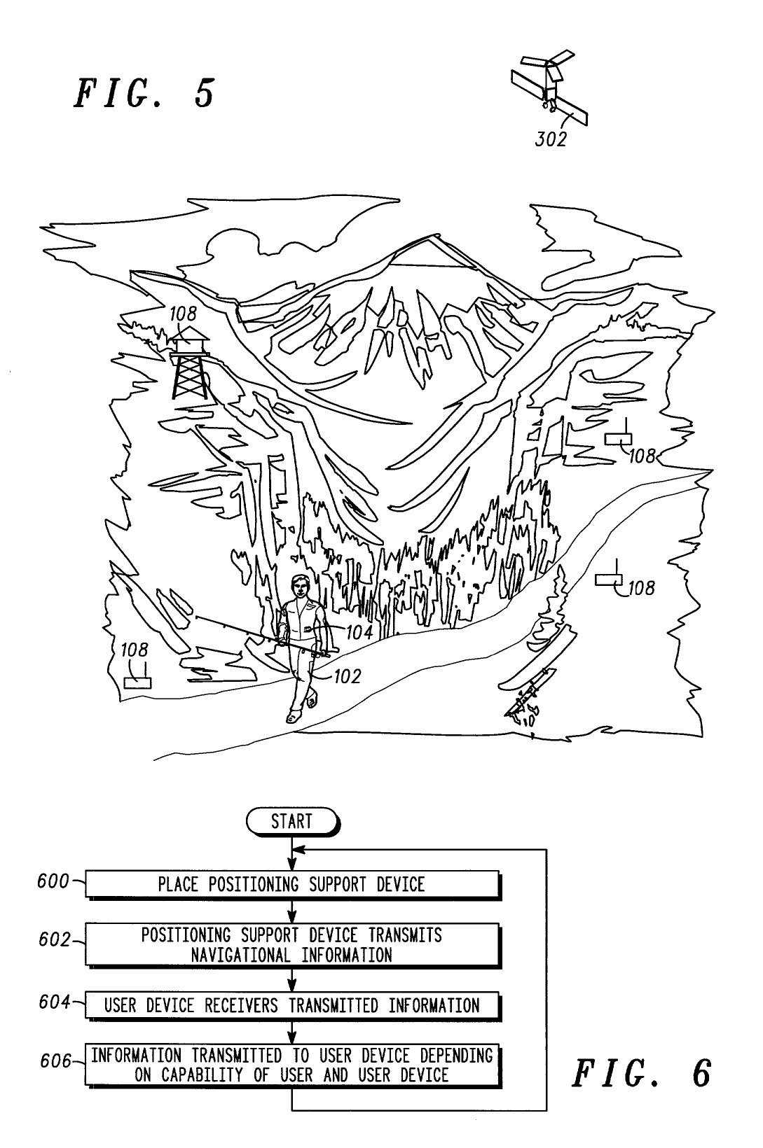

FIG. 5 illustrates an alternative embodiment for land navigation. In this embodiment, positioning support devices 108 can be placed in rural areas (e.g., on firetowers, at public campgrounds, etc.) to assist hikers, campers and the like.

In this embodiment, user 102 is traveling overland. In FIG. 5, the user is traveling on foot although the user 102 could be traveling in a vehicle or on an animal such as a horse, camel, ox, donkey or other beast of burden. The user 102 may be a recreational hiker, a member of a search and rescue team, military personnel on maneuvers or other user 102 requiring accurate navigation overland. User 102 has a personal portable wireless navigational device 104 that receives transmissions from positioning support device 108 and potentially also may receive transmissions from GPS or other publicly accessible remote positioning/navigational support systems 302. Note that while GPS and other publicly accessible remote positioning/navigational support systems can provide accurate absolute and relative position and timing signals, such systems inherently have no contextual knowledge of user 102's local geographic area or of related topographic or cultural features. Thus, positioning support devices 108 can transmit information regarding local fixed or transient navigational hazards, such as a mineshaft, streambed subject to flashfloods, etc., or can provide navigational information, such as preferred or prohibited paths, such that a visually impaired user 102 can stay on a path and thereby enjoy independent participation in such outdoor activities. This is the difference between location information provided by a GPS-like system 302 and navigational information provided by the present invention.

Thus, positioning support devices 108 may communicate using radio frequency signals 304 or using some other type or frequency signal 304 that will propagate in the air. In this embodiment, personal portable wireless navigational device 104 may be attached to or included in an item worn or carried by user 102 for ease of use. Positioning support devices 108, as discussed previously, will communicate navigational information to the personal portable wireless navigational device 104. The type of information communicated to the user 102 again depends on the capabilities of the personal portable wireless navigational device 104 and user 102 capabilities and preferences. Information again can be presented to user 102 as text messages displayed on a screen, other visual inputs, tactile feedback, voice or other audible feedback or other communicative means.

As discussed previously, positioning support devices 108 can be used to mark fixed or moveable navigational hazards or points of interest. In operation, a user 102 with personal portable wireless navigational device 104 is traveling overland and receives navigational information from a positioning support device 108. For example, user 102 may be a member of a rescue team searching for lost persons in a forest or desert. Positioning support devices 108 may be deployed in order to establish grid areas for searching by the member of the rescue team. In another embodiment, positioning support devices 108 can be deployed by a forward scout in a military operation to allow subsequent personnel to follow a safe course. Positioning support devices 108 can be used to mark a path through a National Park or other recreation area for visually impaired hikers.

Additionally, positioning support devices 108 can be used to communicate absolute or relative positions of multiple fixed or transient hazards or other types of relevant locations of interest, such as mineshafts, bear caves, positions of military minefields or of individual mines within a minefield, unexploded ordnance, etc. Thus, if user 102 is equipped with a local geographic information system database which contains one or more of: topographical features or contours, terrain features, cultural features, land use indicators, soil moisture content or bearing strength, ore deposits, or other situationally-relevant information, the additional information provided by positioning support device 108 may be readily merged with user 102's local database information and used to further improve safety, efficiency, and effectiveness of accomplishing user 102's purpose.

FIG. 6 is a flowchart illustrating one method embodiment according to the present invention. In step 600, a positioning support device 108 is placed near a permanent navigational hazard, or a waypoint of interest or relevance, such as an alley or the end of a sidewalk. Alternatively, the positioning support device 108 may be placed in a temporary location where a navigational hazard may exist for only a short period of time, such as on a construction vehicle blocking a right of way. Alternatively, positioning support device 108 can communicate the presence and proximity of vehicles.

In step 602, the positioning support device 108 transmits the navigational information, such as the location of a navigational hazard. This transmission can be a continuous transmission of navigational information, such as the location or proximity of a hazard, or an alert message that will either activate a proximate personal portable wireless navigational device 104 or allow the user 102 to receive notice that a further message will be received. If personal portable wireless navigational device 104 is suitably capability-addressable, it uses signaling information messages with positioning support device 108 to establish compatible communications and formatting of communication link 204, then to configure and enable information content and mechanism of input/output tailored to the needs and capabilities of user 102.

In step 604, the positioning/navigational information message is received at personal portable wireless navigational device 104, which is being carried by a user 102. In step 606, the positioning information is communicated to the user 102. The format and type of information communicated to the user 102 depends on the capabilities of the personal portable wireless navigational device 104 and of user 102, whereas specific information contents presented may also depend on established capabilities and preferences of user 102. Such communications can include spoken audio messages, nonverbal audio messages, vibrations and other forms of tactile sensory outputs, other sensory stimuli, etc. Following completion of the messaging communications, the process starts over again at step 602.

What is claimed:

1. A system for facilitating enhanced personal navigation comprising:
a positioning support device for placement near a navigational feature, the positioning support device transmitting navigational information; and
a user device for receiving navigational information from the positioning support device.

2. The system of claim 1, wherein the user device is operable to communicate the navigational information to a visually impaired user.

3. The system of claim 2, wherein the user device provides the navigational information in a content accessible format.

4. The system of claim 1, wherein multiple positioning Support devices coupled by communication links are placed in multiple locations.

5. The system of claim 1, wherein the positioning support device is operable to adapt the navigational information communicated based on changes in environmental conditions.

6. The system of claim 1, wherein the user device is capability addressable.

7. The system of claim 1, wherein the positioning support device is operable to communicate absolute or relative positions of multiple navigational features.

8. The system of claim 4, wherein the system is operable to adapt to the addition, failure, or removal of positioning support devices of the system.

9. The system of claim 4, wherein one or more of the multiple positioning support devices are operable to receive positioning information from a remote positioning system.

10. The system of claim 4, further comprising a remote server communicating with the positioning support devices and operable to update the information communicated to positioning support devices and to receive information from the positioning support devices.

11. The system of claim 1, wherein the positioning support devices are placed to aid in water navigation.

12. The system of claim 1, wherein positioning support device are placed to aid in overland navigation.

13. A personal navigation unit comprising:
a receiver operable to receive navigational information; and
an output device coupled to the receiver operable to communicate navigational information.

14. The unit of claim 13, wherein the unit is operable to communicate information to a visually impaired user.

15. The unit of claim 13, wherein the output device provides content accessible notification.

16. The unit of claim 13, wherein the navigational information is received from a positioning support device.

17. The unit of claim 13, wherein the navigational information is received from a positioning support device located near a navigational feature.

18. The unit of claim 16, wherein multiple positioning support devices are coupled by a communications link.

19. The unit of claim 18, wherein the multiple positioning support devices are operable to receive positioning support information from a remote positioning system.

20. The unit of claim 13, further comprising a remote server communicating with the positioning support devices and operable to update the information communicated to the positioning support devices and to receive information from the positioning support devices.

21. The unit of claim 13, wherein the receiver is operable to receive navigational information concerning underwater navigation.

22. The unit of claim 13, wherein the receiver is operable to receive navigational information concerning overland navigation.

23. A method for communicating navigational information to a user comprising:
receiving navigation information at a user device; and
communicating the navigational information to the user.

24. The method of claim 23, wherein the step of communicating comprises communicating with a visually impaired user.

25. The method of claim 23, wherein the step of communicating comprises communicating a content accessible notification.

26. The method of claim 23, wherein the step of receiving comprises receiving information from a positioning support device located near a navigational feature.

27. The method of claim 23, further comprising receiving information from multiple positioning support devices coupled together by a communications link.

28. The method of claim 23, further comprising receiving information from a remote positioning system at the positioning support device and communicating the information to the user device.

29. The method of claim 27, further comprising a remote server communicating with the positioning support devices and operable to update the information communicated to the positioning support devices and to receive information from the positioning support devices.

30. The method of claim 23, wherein the step of receiving comprises receiving navigational information concerning underwater navigation.

31. The method of claim 23, wherein the step of receiving comprises receiving navigational information concerning overland navigation.
